(19) United States
(12) Patent Application Publication
(10) Pub. No.: US 2007/0159497 A1
(43) Pub. Date: Jul. 12, 2007

(54) Rotation control

(75) Inventors: Yaniv Gur, Pittsburgh, PA (US); Peter Rapp, Pittsburgh, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/328,957

(22) Filed: Jan. 9, 2006

(51) Int. Cl. G09G 5/00

(52) U.S. Cl. 345/650

(57) ABSTRACT

A rotation control interface is disclosed. A two-dimensional graphical user interface having a first control portion associated with rotation about a first axis and a second control portion associated with rotation about a second axis is displayed. An indication that at least one of the first control portion and the second control portion has been engaged is received. A controlled object associated with the graphical user interface is rotated about the axis or respective axes with which the engaged control portion or portions of the graphical user interface are associated.

### BACKGROUND OF THE INVENTION

Manipulating three dimensional graphics and/or physical objects using a computer mouse or other input device can be daunting to a user due to the two dimensional nature of such devices and, in the case of a graphic, the two dimensional nature of typical computer monitors and/or other display devices. Controls for manipulating three dimensional graphics have been provided in high end computer design, graphics, and animation applications, however such controls typically have not provided an intuitive interface and/or have required that the control itself be rendered and manipulated in a three dimensional graphics space, which may inhibit the performance of lower end, e.g., consumer, host systems. Therefore, there is a need for a rotation control and associated interface for manipulating a three-dimensional graphic or physical object using a two dimensional input device such as a mouse that has an intuitive interface that is relatively simple to use and can be provided even in a lower end computing system, such as a consumer's personal computer, without unacceptable impacts on system and/or application performance.

### BRIEF DESCRIPTION OF THE DRAWINGS

Various embodiments of the invention are disclosed in the following detailed description and the accompanying drawings.

FIG. 1 is a block diagram illustrating an embodiment of a rotation control interface for manipulating a three-dimensional object.

FIG. 2A shows pitch/yaw control 102 of FIG. 1 in a state in which a yaw control portion of the control is pre-selected.

FIG. 2B shows pitch/yaw control 102 of FIG. 1 in a state in which a yaw control portion of the control has been engaged.

FIG. 3A shows pitch/yaw control 102 of FIG. 1 in a state in which a pitch control portion of the control is pre-selected.

FIG. 3B shows pitch/yaw control 102 of FIG. 1 in a state in which a pitch control portion of the control has been engaged.

FIG. 4A shows pitch/yaw control 102 of FIG. 1 in a state in which simultaneous pitch and yaw control is pre-selected.

FIG. 4B shows pitch/yaw control 102 of FIG. 1 in a state in which simultaneous pitch and yaw control has been engaged.

FIG. 5 shows pitch/yaw control 102 of FIG. 1 in a state in which a reset input or control has been pre-selected.

FIG. 6A shows roll control 104 of FIG. 1 in an unselected state.

FIG. 6B shows roll control 104 of FIG. 1 in a pre-selected state.

FIG. 6C shows roll control 104 of FIG. 1 in a selected state.

FIG. 7 is a state diagram illustrating an embodiment of a rotation control interface.

FIG. 8 is a flow chart illustrating an embodiment of a process for rotating an object in response to inputs received via a rotation control interface.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A rotation control and interface for manipulating a three dimensional graphic or physical object using a two dimension input device, such as a computer mouse, is disclosed. A two dimensional control interface is displayed. In some embodiments, the interface includes an optionally stylized double headed arrow for each of one or more of three axes about which a controlled object is able to be rotated in three dimensional virtual (e.g., computer graphical) and/or physical space. Portions of the interface change appearance, e.g., by changing color or other attributes, on mouse rollover and/or other input moving a cursor or other marker over that portion of the control, to indicate that portion of the control would be engaged if a selection input, such as a mouse click, were made at that time. Receipt of a mouse click or other selection input causes a further change of appearance to indicate a selected or engaged state for the associated control. In some embodiments, in the select state a click and drag or similar input causes a controlled object, such as a three-dimensional computer graphic and/or a physical object, to be rotated about one or more axes, as applicable, in some embodiments at a rate proportional to a magnitude of the input, such as the magnitude of a click/drag vector or other input.

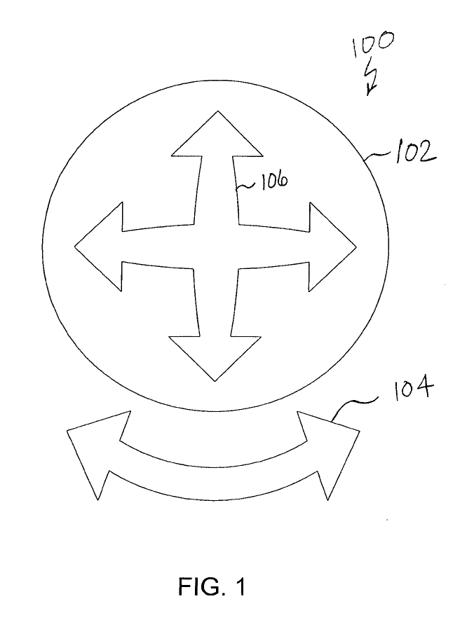

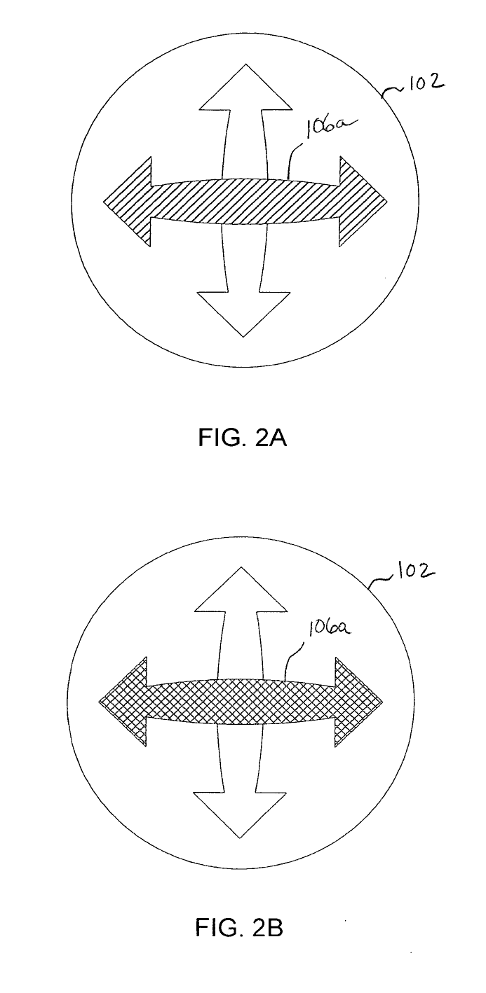

FIG. 1 is a block diagram illustrating an embodiment of a rotation control interface for manipulating a three-dimensional object. In the example shown, rotation control interface 100 includes a pitch/yaw control 102 and a roll control 104. In various embodiments, pitch/yaw control 102 is configured to receive control inputs to control rotation about an x-axis, a y-axis, and/or both at the same time. In some embodiments, pitch/yaw control 102 is rendered as a two dimensional object in which variations in color, shading, etc. are used to give the appearance of a three dimensional stylized sphere. In the example shown, pitch/yaw control 102 includes a four-directional arrow control 106. Rotation about the x-axis, y-axis, and/or both at the same time is provided in response to mouse and/or other input actions with respect to four-directional arrow control 106, as described more fully below in connection with FIGS. 2A-4B. Roll control 104 provides rotation about the z-axis, e.g., in the case of a three-dimensional computer graphic rotation about the axis orthogonal (e.g., perpendicular and coming out of) the display/page. In various embodiments, the roll control 104 is displayed when pitch/yaw control 102 is displayed, is displayed independently of pitch/yaw control 102, and/or a selected one or both of pitch/yaw control 102 and/or roll control 104 is/are displayed at the option of a user. In some embodiments, roll control 104 is not included and rotation control interface 100 includes only pitch/yaw control 102. In some embodiments, rotation control interface 100 is displayed automatically upon selection of a controlled object with which it is associated, e.g., upon selection of a 3D graphic the rotation control interface 100 is used to control. In some embodiments, de-selection of the controlled object causes the rotation control interface 100 to be disable (e.g., closed).

In some embodiments, applicable portions of rotation control interface 100 change appearance upon receipt of a selection input, such as a mouse click and/or a mouse click and drag input. In some embodiments, applicable portions of rotation control interface 100 change appearance to a first changed appearance upon mouse rollover or other pre-selection input and to a second changed appearance upon receipt of a selection input, such as a mouse click. In some embodiments, rotation is provided in response to receiving a selection or engagement input, such as a mouse click and drag in a relevant portion of the control. In some embodiments, the rate of rotation is determined at least in part by a magnitude of the control input, such as a distance the mouse is dragged after being clicked. In some embodiments, the rate is increased or decreased dynamically as the magnitude of the input is varied, for example in response to the mouse/cursor being moved nearer (slower rotation rate) or farther (faster rotation rate) to the original click location.

FIG. 2A shows pitch/yaw control 102 of FIG. 1 in a state in which a yaw control portion of the control is pre-selected. In the example shown, a horizontal double-headed arrow portion 106a of four-directional arrow control 106 of FIG. 1 has been pre-selected, e.g., by a mouse over or other input moving a cursor to a part of horizontal double-headed arrow portion 106a that does not overlap with the vertical double-headed arrow portion of four-directional arrow control 106. In the example shown, the horizontal double-headed arrow portion 106a has changed appearance to a first changed appearance, as indicated in FIG. 2A by showing horizontal double-headed arrow portion 106a in cross hatch, to indicate to a user of the interface 100 that providing a selection input at that time, e.g., clicking the mouse or other input device, would result in the yaw (y-axis rotation) control only being engaged.

FIG. 2B shows pitch/yaw control 102 of FIG. 1 in a state in which a yaw control portion of the control has been engaged. In the example shown, a selection input, such a mouse click (in some embodiments a click-and-hold), has been received at a time when a yaw control portion of the control was pre-selected, e.g., as described above in connection with FIG. 2A. In this example, selection of the yaw control portion of the control has resulted in the horizontal double-headed arrow portion 106a changing appearance to a second changed appearance, as indicated in FIG. 2B by showing horizontal double-headed arrow portion 106a with crisscross fill, to indicate to a user of the interface 100 that providing a direction and/or magnitude input at that time, e.g., dragging the clicked mouse or other input device, would cause the controlled object to be rotated about the y-axis only. In some embodiments, movement of the mouse and/or other input device made while the interface display is in the state shown in FIG. 2B results in a controlled object being rotated about the y-axis only. In some embodiments, the rate of rotation varies based at least in part on a magnitude of the input, e.g., a distance the cursor is moved from a location in which the yaw control was first engaged (e.g., mouse dragged after clicking and while holding the mouse button down). In various embodiments, a de-select input, such as releasing the mouse button, causes the interface to return to the display state shown in FIG. 2A (e.g., if the cursor remains over a part of the horizontal double-headed arrow portion 106a that does not overlap the vertical double-headed arrow portion) and/or the unselected display state shown in FIG. 1, as applicable.

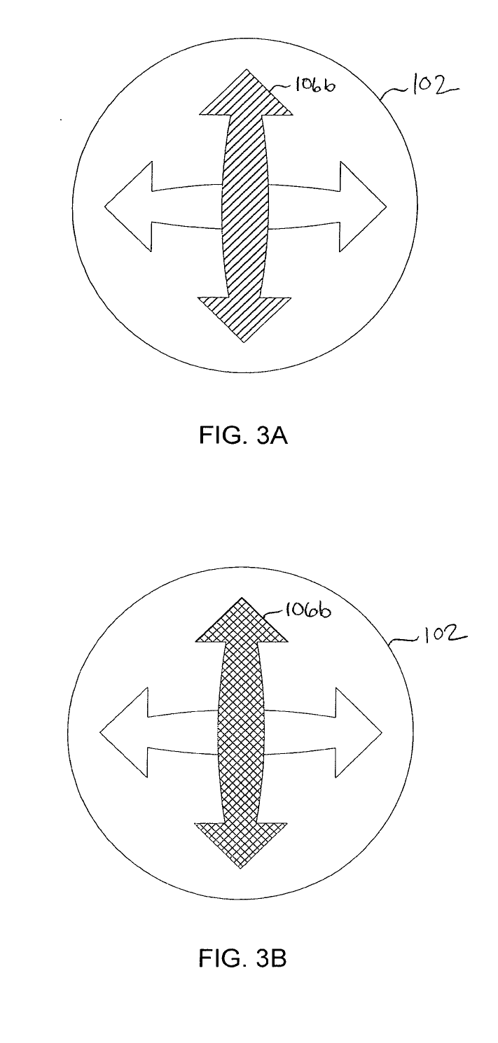

FIG. 3A shows pitch/yaw control 102 of FIG. 1 in a state in which a pitch control portion of the control is pre-selected. In the example shown, a vertical double-headed arrow portion 106b of four-directional arrow control 106 of FIG. 1 has been pre-selected, e.g., by a mouse over or other input moving a cursor to a part of vertical double-headed arrow portion 106b that does not overlap with the horizontal double-headed arrow portion 106a of four-directional arrow control 106. In the example shown, the vertical double-headed arrow portion 106b has changed appearance to a first changed appearance, as indicated in FIG. 3A by showing vertical double-headed arrow portion 106b in cross hatch, to indicate to a user of the interface 100 that providing a selection input at that time, e.g., clicking the mouse or other input device, would result in the pitch (x-axis rotation) control only being engaged.

FIG. 3B shows pitch/yaw control 102 of FIG. 1 in a state in which a pitch control portion of the control has been engaged. In the example shown, a selection input, such a mouse click (in some embodiments a click-and-hold), has been received at a time when a pitch control portion of the control was pre-selected, e.g., as described above in connection with FIG. 3A. In this example, selection of the pitch control portion of the control has resulted in the vertical double-headed arrow portion 106b changing appearance to a second changed appearance, as indicated in FIG. 3B by showing vertical double-headed arrow portion 106b with crisscross fill, to indicate to a user of the interface 100 that providing a direction and/or magnitude input at that time, e.g., dragging the clicked mouse or other input device, would cause the controlled object to be rotated about the x-axis only. In some embodiments, movement of the mouse and/or other input device made while the interface display is in the state shown in FIG. 3B results in a controlled object being rotated about the x-axis only. In some embodiments, the rate of rotation varies based at least in part on a magnitude of the input, e.g., a distance the cursor is moved from a location in which the yaw control was first engaged (e.g., mouse dragged after clicking and while holding the mouse button down). In various embodiments, a de-select input, such as releasing the mouse button, causes the interface to return to the display state shown in FIG. 3A (e.g., if the cursor remains over a part of the vertical double-headed arrow portion 106b that does not overlap the horizontal double-headed arrow portion 106a) and/or the unselected display state shown in FIG. 1, as applicable.

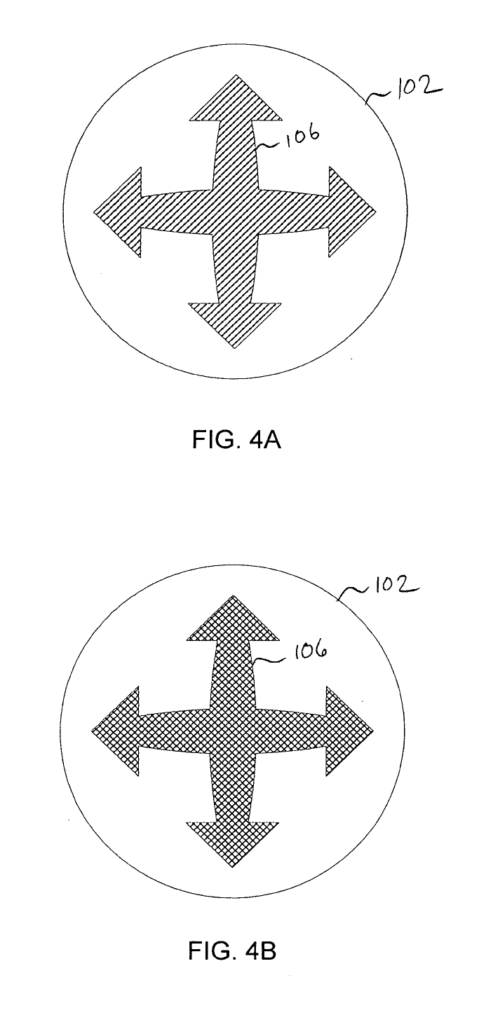

FIG. 4A shows pitch/yaw control 102 of FIG. 1 in a state in which simultaneous pitch and yaw control is pre-selected. In the example shown, the entire four-directional arrow control 106 of FIG. 1 has been pre-selected, e.g., by a mouse over or other input moving a cursor to a part of four-directional arrow control 106 at which horizontal double-headed arrow portion 106a and vertical double-headed arrow portion 106b intersect and/or overlap. In the example shown, the four-directional arrow control 106 has changed appearance to a first changed appearance, as indicated in FIG. 4A by showing four-directional arrow control 106 in cross hatch, to indicate to a user of the interface 100 that providing a selection input at that time, e.g., clicking the mouse or other input device, would result in simultaneous pitch (x-axis rotation) and yaw (y-axis rotation) control being engaged.

FIG. 4B shows pitch/yaw control 102 of FIG. 1 in a state in which simultaneous pitch and yaw control has been engaged. In the example shown, a selection input, such a mouse click (in some embodiments a click-and-hold), has been received at a time when simultaneous pitch and yaw control was pre-selected, e.g., as described above in connection with FIG. 4A. In this example, selection of simultaneous pitch and yaw control has resulted in the four-directional arrow control 106 changing appearance to a second changed appearance, as indicated in FIG. 4B by showing four-directional arrow control 106 with crisscross fill, to indicate to a user of the interface 100 that providing a direction and/or magnitude input at that time, e.g., dragging the clicked mouse or other input device, would cause the controlled object to be rotated about the x-axis, the y-axis, or both, depending on the magnitude and/or direction of the input. In some embodiments, movement of the mouse and/or other input device made while the interface display is in the state shown in FIG. 4B results in a controlled object being rotated about the x-axis, the y-axis, or both, depending on the magnitude and/or direction of the input. In some embodiments, in the state shown in FIG. 4B x-axis rotation is determined by a y-axis component of a mouse click-and-drag or other input vector and y-axis rotation is determined by an x-axis component of the mouse click-and-drag or other input vector. In some embodiments, the rate of rotation varies based at least in part on a magnitude of the input and/or an applicable component thereof, e.g., a distance the cursor is moved from a location in which the control was first engaged (e.g., mouse dragged after clicking and while holding the mouse button down). In various embodiments, a de-select input, such as releasing the mouse button, causes the interface to return to the display state shown in FIG. 4A (e.g., if the cursor remains over a part of four-directional arrow control 106 at which horizontal double-headed arrow portion 106a and vertical double-headed arrow portion 106b intersect and/or overlap) and/or the unselected display state shown in FIG. 1, as applicable.

In some embodiments, the pitch/yaw control 102 does not change appearance upon mouse rollover or other pre-selection input and the display states shown in FIGS. 2A, 3A, and 4A are not provided.

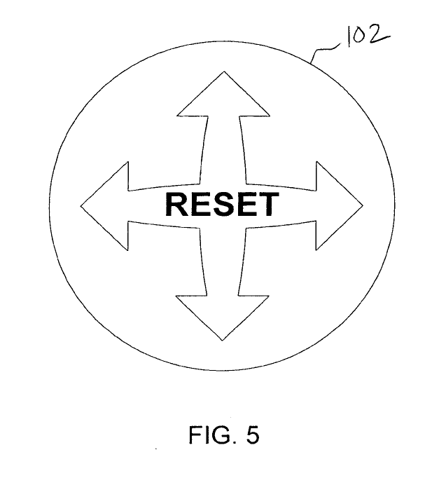

FIG. 5 shows pitch/yaw control 102 of FIG. 1 in a state in which a reset input or control has been pre-selected. In the example shown, the word “RESET” is displayed in prominent text on or over at least a portion of pitch/yaw control 102. In some embodiments, the reset pre-select state shown in FIG. 5 is entered by selecting a prescribed or configured function or shortcut key. In some embodiments, clicking or otherwise selecting the pitch/yaw control 102 while it is in the display state shown in FIG. 5 results in the controlled object being reset to an origin (0,0) or a prior, e.g., a last saved, position and/or state. In some embodiments, the pitch/yaw control 102 does not change appearance upon pre-selection and/or selection of a reset. In some embodiments, no reset functionality is provided.

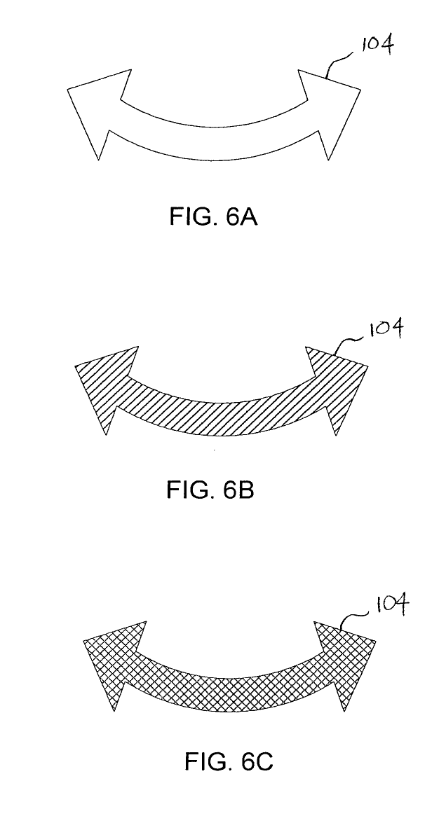

FIG. 6A shows roll control 104 of FIG. 1 in an unselected state.

FIG. 6B shows roll control 104 of FIG. 1 in a pre-selected state. In the example shown, roll control 104 of FIG. 1 has been pre-selected, e.g., by a mouse over or other input moving a cursor to a location on roll control 104. In the example shown, roll control 104 has changed appearance to a first changed appearance, as indicated in FIG. 6B by showing roll control 104 in cross hatch, to indicate to a user of the interface 100 that providing a selection input at that time, e.g., clicking the mouse or other input device, would result in roll (z-axis rotation) control being engaged.

FIG. 6C shows roll control 104 of FIG. 1 in a selected state. In the example shown, a selection input, such a mouse click (in some embodiments a click-and-hold), has been received at a time when roll control 104 was pre-selected, e.g., as described above in connection with FIG. 6B. In this example, selection of roll control 104 has resulted in roll control 104 changing appearance to a second changed appearance, as indicated in FIG. 6C by showing roll control 104 with crisscross fill, to indicate to a user of the interface 100 that providing a direction and/or magnitude input at that time, e.g., dragging the clicked mouse or other input device, would cause the controlled object to be rotated about the z-axis. In some embodiments, movement of the mouse and/or other input device made while the interface display is in the state shown in FIG. 6C results in a controlled object being rotated about the z-axis. In some embodiments, the rate of rotation varies based at least in part on a magnitude of the input, e.g., a distance the cursor is moved from a location in which the roll control 104 was first engaged (e.g., mouse dragged after clicking and while holding the mouse button down). In various embodiments, a de-select input, such as releasing the mouse button, causes the interface to return to the display state shown in FIG. 6C (e.g., if the cursor remains over a part of roll control 104) and/or the unselected display state shown in FIG. 6A, as applicable.

In some embodiments, roll control is not provided and the roll control 104 and display states shown in FIGS. 6A-6C are not used or included in rotation control interface 100.

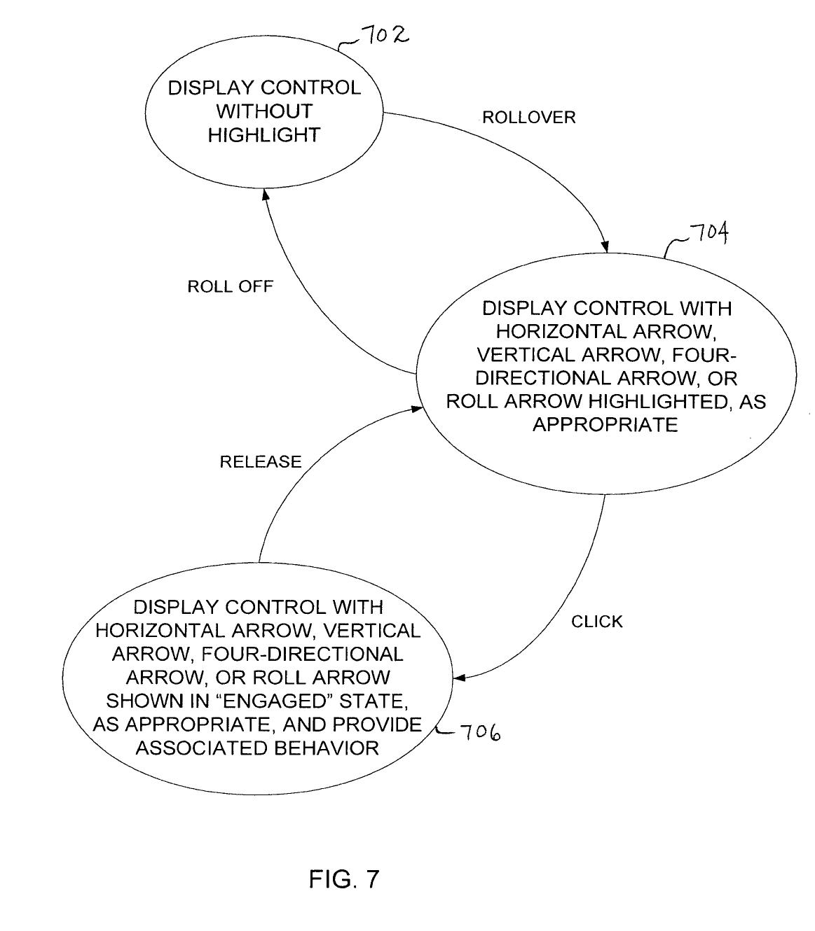

FIG. 7 is a state diagram illustrating an embodiment of a rotation control interface. In the example shown, the rotation control interface is displayed initially in a first, unselected state 702 in which all portions of the control are displayed with an default/unselected appearance, e.g., as in FIGS. 1 and 6A. A mouse rollover or other input indicating pre-selection of at least a portion of the controls results in a transition to a pre-selected state 704 in which pre-selected portions are shown in a first changed (pre-selected) display state, e.g., as in FIGS. 2A, 3A, 4A, and 6B, to indicate that a selection input received at that time would result in control functions associated with the indicated pre-selected portions of the control interface being engaged. Receipt of a selection input, e.g., a mouse click, at a time when at least a portion of the rotation control interface is pre-selected results in a transition to an engaged state 706 in which one or more control functions associated with those portions of the control interface that were in a pre-selected state at the time the selection input was received are engaged and provided and the corresponding portions of the control interface changed to a second changed (engaged) display state, e.g., as in FIGS. 2B, 3B, 4B, and 6C. A de-select input, such as releasing a mouse button or other input device, in this example results in a transition from engaged state 706 to pre-selected state 704, in which previously engaged portions of the control interface appear in the first changed (pre-selected) state so long as the cursor remains positioned over them. Mouse roll off or other input moving a cursor out of the area of the control interface results in a return to the unselected display state 702. In some alternative embodiments, direct transitions between unselected state 702 and engaged state 706 are possible.

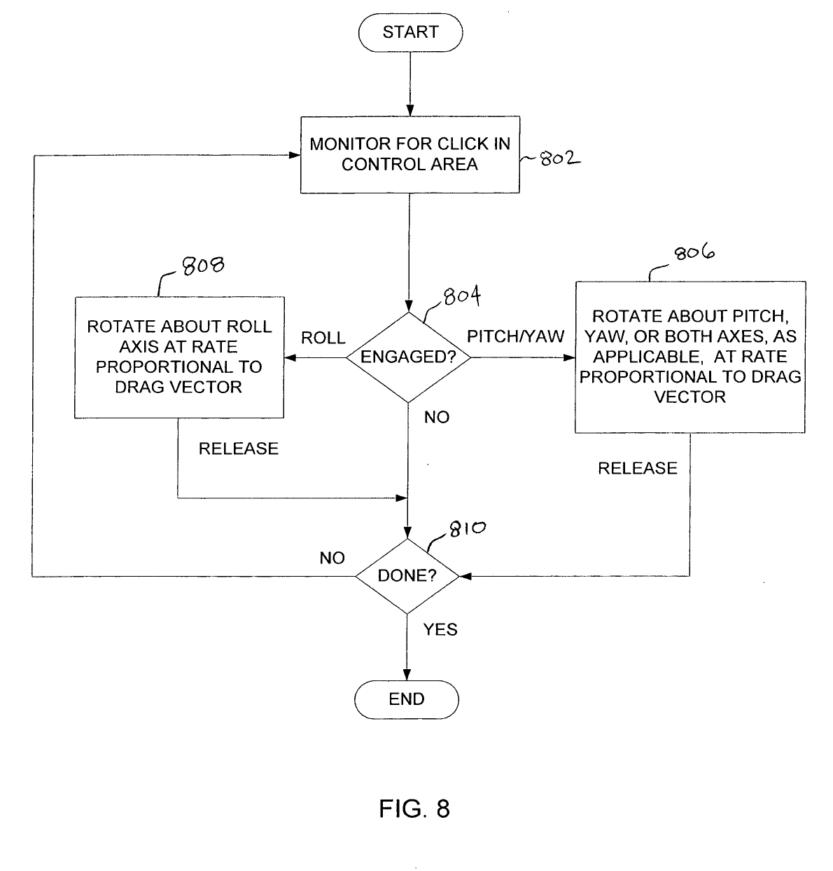

FIG. 8 is a flow chart illustrating an embodiment of a process for rotating an object in response to inputs received via a rotation control interface. At 802, the control interface is monitored for inputs indicating that at least a portion of the rotation control has been engaged, e.g., a user has clicked a mouse while the cursor is positioned at a location on the control interface that corresponds to a control function. If an indication is received that the control has been engaged (804), pitch and/or yaw control (806) or roll control (808) is provided, as applicable, e.g., based on which portion(s) of the control interface were engaged, until a de-select or release indication, e.g., release of the mouse button, is received. In some embodiments, rotation is provided by sending one or more control signals and/or data to a computer graphic rendering application, device, or process with which the controlled object is associated, e.g., an application, device, or process used to render and/or create/edit the controlled object. The process continues until an indication is received that the user is done using the interface and/or control (810), e.g., the user exits or minimizes the interface, after which the process ends.

In some embodiments, the control interface 100 is implemented as an NSControl subclass (Cocoa) written in Objective-C. Internally, the control stores rotation values for the x-, y-, and z-axes. After a mouseDown event, each mouseDragged event is compared with the previous location of the mouse, producing a velocity vector that indicates the speed and direction on the x-y plane of the display device (e.g., computer monitor). This is then applied to the first two rotation values, e.g., for pitch and yaw control. Rotation state is persistent (much like the value of an NSSlider is persistent) so the user's next use of the control will rotate the object starting from its current orientation, rather than snapping back to (0,0,0). When roll control is invoked, in some embodiments left-right movements of the mouse are mapped to make the controlled object spin on just the roll axis. In various embodiments, minimum and/or maximum values are and/or can optionally be enforced on one, two, or all three axes.

In various embodiments, the control interface 100 is used to provide rotation control of three-dimensional graphics, including without limitation in the context of content authoring applications typically used by consumers and others on relatively inexpensive and less powerful computer systems, such as a personal computer, such as word processing, slideshow/presentation (e.g., charts and graphs), home/small business desktop publishing, landscaping and architectural design, web authoring, computer aided design, animation, and any other application able to be used to create and manipulate three-dimensional graphics. Providing a control that is both intuitive and relatively simple to render and provide in some embodiments makes it possible for rotation control of three-dimensional objects to be provided effectively via a relatively less powerful computing system without adversely affecting performance to an unacceptable degree.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of controlling rotation, comprising:
displaying a two-dimensional graphical user interface having a first control portion associated with rotation about a first axis and a second control portion associated with rotation about a second axis;
receiving an indication that at least one of the first control portion and the second control portion has been engaged; and
rotating a controlled object associated with the graphical user interface about the axis or respective axes with which the engaged control portion or portions of the graphical user interface are associated.

2. A method as recited in claim 1, wherein one or both of a rate and a direction of rotation is determined at least in part by the indication.

3. A method as recited in claim 1, wherein one or both of a rate and a direction of rotation is determined at least in part by a user input comprising or in addition to the is indication.

4. A method as recited in claim 1, wherein one or both of a rate and a direction of rotation is determined at least in part by a drag vector determined at least in part by comparing a first cursor position at which a cursor was located when the control was first engaged and a current cursor position.

5. A method as recited in claim 4, wherein the first cursor position corresponds to a first point at which a mouse button is clicked and the current cursor position corresponds to a second point to which the mouse is dragged, if at all.

6. A method as recited in claim 1, further comprising:
receiving an indication that the at least one of the first control portion and the second control portion has been pre-selected but not yet engaged; and
changing the appearance of the at least one of the first control portion and the second control portion from an initial unselected appearance state to a pre-selected appearance state.

7. A method as recited in claim 1, further comprising changing the appearance of the at least one of the first control portion and the second control portion to an engaged appearance state in response to receiving the indication.

8. A method as recited in claim 1, wherein the indication comprises a mouse click input received at a time when an associated cursor was positioned on the at least one of the first control portion and the second control portion.

9. A method as recited in claim 1, wherein the first control portion and the second control portion overlap in an overlap area.

10. A method as recited in claim 1, wherein the first control portion and the second control portion overlap in an overlap area and an engagement indication associated with the overlap area results in simultaneous control of rotation about the first and second axes being engaged and provided.

11. A method as recited in claim 1, wherein the user interface includes a third control portion associated with rotation about a first axis.

12. A method as recited in claim 1, wherein the first control portion comprises a double-headed arrow oriented perpendicular to the first axis of rotation.

13. A method as recited in claim 1, wherein the first control portion comprises a first double-headed arrow oriented perpendicular to the first axis of rotation and the second control portion comprises a second double-headed arrow oriented perpendicular to the first double-headed arrow, perpendicular to the second axis of rotation, and parallel to the first axis of rotation.

14. A method as recited in claim 13, wherein the graphical user interface further comprises a circular graphic on which first and second double-headed arrows are located.

15. A method as recited in claim 14, wherein the circular graphic comprises a two-dimensional graphic having style attributes that give it the appearance of a stylized sphere.

16. A method as recited in claim 1, further comprising receiving a reset function pre-select input and changing the graphical user interface to a reset pre-select display state in response to the reset function pre-select input.

17. A method as recited in claim 16, further comprising receiving a select input at a time when the graphical user interface is in the reset pre-select display state and resetting the controlled object to a three-dimensional orientation associated with a reset state.

18. A method as recited in claim 1, wherein the controlled object comprises a physical object.

19. A method as recited in claim 1, wherein the controlled object comprises a three-dimensional graphic.

20. A method as recited in claim 1, wherein the controlled object comprises a three-dimensional graphic associated with one or more of the following software applications: word processing, presentation, desktop publishing, landscaping and architectural design, web authoring, computer aided design, and animation.

21. A method as recited in claim 1, wherein rotating a controlled object associated with the graphical user interface about the axis or respective axes with which the engaged control portion or portions of the graphical user interface are associated comprises causing a computer graphic rendering application or process to rotate the controlled object.

22. A user interface for controlling rotation, comprising:
a two-dimensional graphical user interface comprising:
a first control portion associated with rotation about a first axis; and
a second control portion associated with rotation about a second axis;
wherein engagement of at least one of the first control portion and the second control portion causes a controlled object associated with the graphical user interface to be rotated about the axis or respective axes with which the engaged control portion or portions of the graphical user interface are associated.

23. A system for controlling rotation, comprising:
a display device; and
a processor configured to:
display via the display device a two-dimensional graphical user interface having a first control portion associated with rotation about a first axis and a second control portion associated with rotation about a second axis;
receive an indication that at least one of the first control portion and the second control portion has been engaged; and
rotate a controlled object associated with the graphical user interface about the axis or respective axes with which the engaged control portion or portions of the graphical user interface are associated.

24. A computer program product for controlling rotation, the computer program product being embodied in a computer readable medium and comprising computer instructions for:
displaying a two-dimensional graphical user interface having a first control portion associated with rotation about a first axis and a second control portion associated with rotation about a second axis;
receiving an indication that at least one of the first control portion and the second control portion has been engaged; and
rotating a controlled object associated with the graphical user interface about the axis or respective axes with which the engaged control portion or portions of the graphical user interface are associated.
